(19) United States
(12) Patent Application Publication
(10) Pub. No.: US 2024/0345201 A1
(43) Pub. Date: Oct. 17, 2024

(54) METHOD FOR CARRIER PHASE BASED POSITIONING

(71) Applicant: ZTE CORPORATION, Shenzhen (CN)

(72) Inventors: Focai PENG, Shenzhen (CN); Chuangxin JIANG, Shenzhen (CN); Guozeng ZHENG, Shenzhen (CN); Zhaohua LU, Shenzhen (CN); Juan LIU, Shenzhen (CN); Feng BI, Shenzhen (CN)

(73) Assignee: ZTE CORPORATION, Shenzhen (CN)

(21) Appl. No.: 18/655,727

(22) Filed: May 6, 2024

Related U.S. Application Data
(63) Continuation of application No. PCT/CN2022/081690, filed on Mar. 18, 2022.

(51) Int. Cl. G01S 5/02; H04W 64/00

(52) U.S. Cl. CPC G01S 5/0273; H04W 64/00

(57) ABSTRACT

Method, device and computer program product for wireless communication are provided. A method includes: receiving, by a wireless communication terminal from a wireless communication node, configuration information of a reference signal for positioning; measuring, by the wireless communication terminal, the reference signal for positioning according to the configuration information; and reporting, by the wireless communication terminal to the wireless communication node, a measurement result of the reference signal for positioning.

### CROSS-REFERENCE TO RELATED PATENT APPLICATIONS

This application is a Continuation of PCT Application No. PCT/CN2022/081690, filed Mar. 18, 2022, which is incorporated herein by reference in its entirety.

### TECHNICAL FIELD

This document is directed generally to wireless communications, and in particular to how to improve positioning accuracy for 5G-NR-based positioning.

### BACKGROUND

Currently, requirements on positioning (localization) are rising up. For example, in a park (especially, an underground park), it is not easy to find a car (especially, during busy hours). The 5th Generation mobile communication system (5G, New Radio access technology, 5G-NR) provides a method on positioning, including, Positioning Reference Signal (PRS, from a base station, gNB) and Sounding Reference Signal (SRS, from a User equipment, UE) on a radio side.

### SUMMARY

However, the positioning accuracy of the existing 5G-NR-based positioning solutions may not be high enough (e.g., one meter or worse). In some harsh environment (e.g., dense urban area), the positioning accuracy of the existing 5G-NR-based positioning solution might be even worse. In some commerce cases, a positioning accuracy of 0.2 meter is required. In some cases, the target of some commerce requirements (e.g., 0.2 meter) is hard to be achieved by the existing 5G-NR-based positioning solution. To this end, this disclosure is related to positioning accuracy improvement for 5G-NR-based positioning.

This document relates to methods, systems and devices for Carrier Phase Based Positioning.

One aspect of the present disclosure relates to a wireless communication method. In an embodiment, the wireless communication method includes: receiving, by a wireless communication terminal from a wireless communication node, configuration information of a reference signal for positioning; measuring, by the wireless communication terminal, the reference signal for positioning according to the configuration information; and reporting, by the wireless communication terminal to the wireless communication node, a measurement result of the reference signal for positioning.

Another aspect of the present disclosure relates to a wireless communication method. In an embodiment, the wireless communication method includes: receiving, by a wireless communication node from a location management function, configuration information of a reference signal for positioning; measuring, by the wireless communication node, the reference signal for positioning (e.g., from a wireless communication terminal) according to the configuration information; and reporting, by the wireless communication node to the location management function, a measurement result of the reference signal for positioning.

Another aspect of the present disclosure relates to a wireless communication terminal. In an embodiment, the wireless communication terminal includes a communication unit and a processor. The processor is configured to: receive, by the communication unit from a wireless communication node, configuration information of a reference signal for positioning; measure the reference signal for positioning according to the configuration information; and report, by the communication unit to the wireless communication node, a measurement result of the reference signal for positioning.

Another aspect of the present disclosure relates to a wireless communication node. In an embodiment, the wireless communication node includes a communication unit and a processor. The processor is configured to: receive, by the communication unit from a location management function, configuration information of a reference signal for positioning; measure the reference signal for positioning (e.g., from a wireless communication terminal) according to the configuration information; and report, by the communication unit to the location management function, a measurement result of the reference signal for positioning.

Various embodiments may preferably implement the following features:

Preferably or in some embodiments, the reference signal for positioning comprises a sequence mapped to multiple contiguous symbols.

Preferably or in some embodiments, a number of the contiguous symbols is determined according to a positioning accuracy requirement.

Preferably or in some embodiments, the method includes: measuring, by the wireless communication terminal, one or more carrier phases of the reference signal for positioning on one or more paths.

Preferably or in some embodiments, the method includes: measuring, by the wireless communication terminal, a carrier phase of the reference signal for positioning on a first arrival path.

Preferably or in some embodiments, the method includes: measuring, by the wireless communication terminal, a carrier phase of the reference signal for positioning on a path different from a first arrival path.

Preferably or in some embodiments, the measurement result of the reference signal for positioning comprises at least one of: one or more carrier phase differences between paths; one or more carrier phase differences between frequency layers; one or more carrier phase differences between resources of the reference signal for positioning; or one or more carrier phase differences between transmission reception points.

Preferably or in some embodiments, the method includes: reporting, by the wireless communication terminal to the wireless communication node, one or more carrier phases of the reference signal for positioning with an indication of line of sight or non-line of sight.

Preferably or in some embodiments, the method includes: reporting, by the wireless communication terminal to the wireless communication node, one or more carrier phases of the reference signal for positioning with the indication of line of sight or non-line of sight with a confidence level.

Preferably or in some embodiments, a report of the one or more carrier phases of the reference signal for positioning is absent in response to a probability of non-line of sight exceeding a threshold.

Preferably or in some embodiments, the threshold is configured by a long-term evolution positioning protocol layer.

Preferably or in some embodiments, the method includes: determining, by the wireless communication terminal, a signal to noise ratio of the reference signal for positioning when measuring the reference signal for positioning.

Preferably or in some embodiments, the method includes: reporting, by the wireless communication terminal to the wireless communication node, one or more carrier phases of the reference signal for positioning with at least one of: a signal to noise ratio, a signal to interference plus noise ratio, a reference signal received power, or a reference signal received quality.

Preferably or in some embodiments, the method includes: reporting, by the wireless communication terminal to the wireless communication node, the measurement result of the reference signal for positioning on a first arrival path with a fine granularity.

Preferably or in some embodiments, the method includes: reporting, by the wireless communication terminal to the wireless communication node, the measurement result of the reference signal for positioning on a path having a strongest receiving power with a fine granularity.

Preferably or in some embodiments, the method includes: reporting, by the wireless communication terminal to the wireless communication node, the measurement result of the reference signal for positioning on a path different from the first arrival path with a coarse granularity.

Preferably or in some embodiments, the method includes: reporting, by the wireless communication terminal to the wireless communication node, a differential report associated to a carrier phase of the reference signal.

Preferably or in some embodiments, the differential report comprises a differential value relative to the carrier phase of a first arrival path.

Preferably or in some embodiments, the method includes: reporting, by the wireless communication terminal to the wireless communication node, at least one of: an identifier of the reference signal for positioning; an identifier of a resource of the reference signal for positioning; or an identifier of a set of the reference signal for positioning.

Preferably or in some embodiments, the method includes: reporting, by the wireless communication terminal to the wireless communication node, a differential report with a link between a frequency layer and a reference frequency layer.

Preferably or in some embodiments, the method includes: reporting, by the wireless communication terminal to the wireless communication node, the measurement result based on each resource of the reference signal for positioning.

Preferably or in some embodiments, the method includes: reporting, by the wireless communication terminal to the wireless communication node, Q candidates of carrier phases of the reference signal for positioning or Q candidates of carrier phase differences of the reference signal for positioning, wherein Q is an integer.

Preferably or in some embodiments, the Q candidates of carrier phases or the Q candidates of carrier phase differences of the reference signal for positioning comprise Q integers of integer parts and corresponding Q floats of fractional parts.

Preferably or in some embodiments, the method includes: reporting, by the wireless communication terminal to the wireless communication node, Q pair candidates of carrier phase differences of the reference signal for positioning, wherein Q is an integer.

Preferably or in some embodiments, the method includes: reporting, by the wireless communication terminal to the wireless communication node, Q pair candidates of carrier phases or carrier phase differences of the reference signal for positioning after a de-correlation process, wherein Q is an integer.

Preferably or in some embodiments, the method includes: reporting, by the wireless communication terminal to the wireless communication node, Q pair candidates of carrier phases or carrier phase differences of the reference signal for positioning after a de-correlation process and an optimal estimation process, wherein Q is an integer.

Preferably or in some embodiments, the method includes: reporting, by the wireless communication terminal to the wireless communication node, a gesture of the wireless communication terminal with timing error groups not in one plane.

Preferably or in some embodiments, the method includes: reporting, by the wireless communication terminal to the wireless communication node, a carrier phase of the reference signal for positioning based on a channel impulse response.

Preferably or in some embodiments, a number of times of measuring the reference signal for positioning before the measurement result being reported is configured by a network.

Preferably or in some embodiments, the method includes: reporting, by the wireless communication terminal to the wireless communication node, a carrier phase of the reference signal for positioning with at least one of: a location of the wireless communication terminal; an indication of a measurement number; or distance information between the wireless communication terminal and the wireless communication node.

Preferably or in some embodiments, the method includes: measuring, by the wireless communication node, one or more carrier phases of the reference signal for positioning on one or more paths with the same receiving timing error group.

Preferably or in some embodiments, the method includes: reporting, by the wireless communication node to the location management function, one or more carrier phases of the reference signal for positioning with an indication of receiving timing error group.

Preferably or in some embodiments, the method includes: measuring, by the wireless communication node, one or more carrier phases of the reference signal for positioning on one or more paths.

Preferably or in some embodiments, the method includes: measuring, by the wireless communication node, a carrier phase of the reference signal for positioning on a first arrival path.

Preferably or in some embodiments, the method includes: measuring, by the wireless communication node, a carrier phase of the reference signal for positioning on a path different from a first arrival path.

Preferably or in some embodiments, the method includes: reporting, by the wireless communication node to the location management function, one or more carrier phases of the reference signal for positioning with an indication of line of sight or non-line of sight.

Preferably or in some embodiments, the method includes: reporting, by the wireless communication node to the location management function, one or more carrier phases of the reference signal for positioning with the indication of line of sight or non-line of sight with a confidence level.

Preferably or in some embodiments, the method includes: determining, by the wireless communication node, a signal to noise ratio of the reference signal for positioning when measuring the reference signal for positioning.

Preferably or in some embodiments, the method includes: reporting, by the wireless communication node to the location management function, one or more carrier phases of the reference signal for positioning with at least one of: a signal to noise ratio, a signal to interference plus noise ratio, a reference signal received power, or a reference signal received quality.

Preferably or in some embodiments, the method includes: reporting, by the wireless communication node to the location management function, the measurement result of the reference signal for positioning on a first arrival path with a fine granularity.

Preferably or in some embodiments, the method includes: reporting, by the wireless communication node to the location management function, the measurement result of the reference signal for positioning on a path having a strongest receiving power with a fine granularity.

Preferably or in some embodiments, the method includes: reporting, by the wireless communication node to the location management function, the measurement result of the reference signal for positioning on a path different from the first arrival path with a coarse granularity.

Preferably or in some embodiments, the method includes: reporting, by the wireless communication node to the location management function, a differential report associated to a carrier phase of the reference signal.

Preferably or in some embodiments, the method includes: reporting, by the wireless communication node to the location management function, at least one of: an identifier of the reference signal for positioning; an identifier of a resource of the reference signal for positioning; or an identifier of a set of the reference signal for positioning.

Preferably or in some embodiments, the method includes: reporting, by the wireless communication node to the location management function, a differential report with a link between a frequency layer and a reference frequency layer.

Preferably or in some embodiments, the method includes: reporting, by the wireless communication node to the location management function, the measurement result based on each resource of the reference signal for positioning.

Preferably or in some embodiments, the method includes: reporting, by the wireless communication node to the location management function, Q candidates of carrier phases of the reference signal for positioning or Q candidates of carrier phase differences of the reference signal for positioning, wherein Q is an integer.

Preferably or in some embodiments, the method includes: reporting, by the wireless communication node to the location management function, Q pair candidates of carrier phase differences of the reference signal for positioning, wherein Q is an integer.

Preferably or in some embodiments, the method includes: reporting, by the wireless communication node to the location management function, Q pair candidates of carrier phases or carrier phase differences of the reference signal for positioning after a de-correlation process, wherein Q is an integer.

Preferably or in some embodiments, the method includes: reporting, by the wireless communication node to the location management function, Q pair candidates of carrier phases or carrier phase differences of the reference signal for positioning after a de-correlation process and an optimal estimation process, wherein Q is an integer.

Preferably or in some embodiments, the method includes: reporting, by the wireless communication node to the location management function, a gesture of the wireless communication terminal with timing error groups not in one plane.

Preferably or in some embodiments, the method includes: reporting, by the wireless communication node to the location management function, a carrier phase of the reference signal for positioning based on a channel impulse response.

Preferably or in some embodiments, the method includes: reporting, by the wireless communication node to the location management function, a carrier phase of the reference signal for positioning with at least one of: a location of the wireless communication terminal; an indication of a measurement number; or distance information between the wireless communication terminal and the wireless communication node.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a PRS transmission according to an embodiment of the present disclosure.

FIG. 2 shows a schematic diagram of an SRS transmission according to an embodiment of the present disclosure.

FIG. 3 shows a schematic illustration of a travelling radio wave.

FIG. 4. shows a schematic diagram of transmission of a reference signal for positioning according to an embodiment of the present disclosure.

FIG. 5 shows a schematic diagram of positioning of a moving device using a receiver with known location according to an embodiment of the present disclosure.

FIG. 6 is a graph depicting the accuracy in position with carrier phase measurement according to an embodiment of the present disclosure.

FIG. 7 shows an example of a schematic diagram of a wireless terminal according to an embodiment of the present disclosure.

FIG. 8 shows an example of a schematic diagram of a wireless network node according to an embodiment of the present disclosure.

FIG. 9 shows a flowchart of a wireless communication method according to an embodiment of the present disclosure.

FIG. 10 shows a flowchart of a wireless communication method according to an embodiment of the present disclosure.

### DETAILED DESCRIPTION

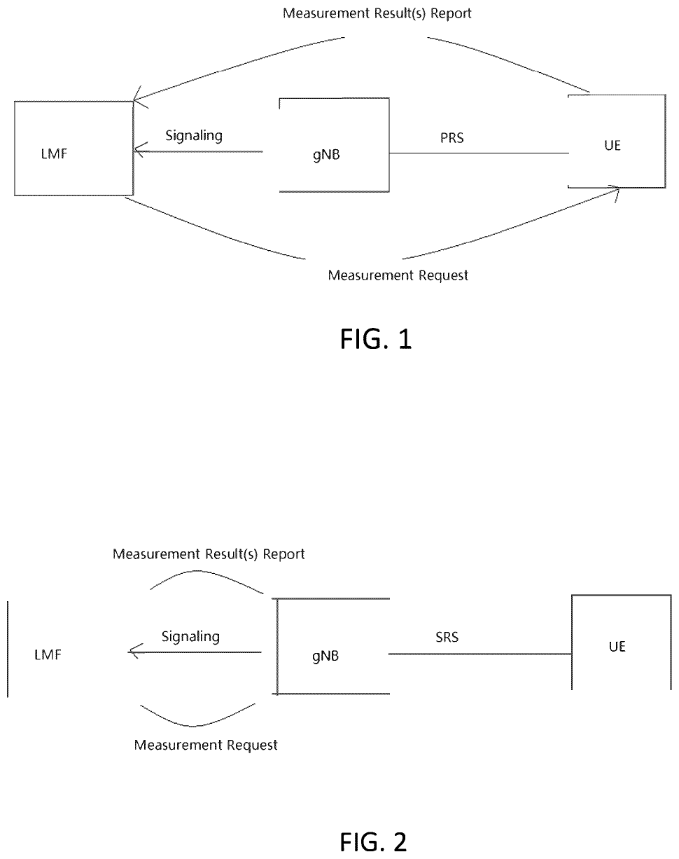

In an embodiment, in the downlink (DL) as shown in FIG. 1, the PRS is transmitted by one or multiple gNB. Usually, to achieve a “good” (sufficient) positioning accuracy, multiple gNB may be involved, e.g., three base stations. A UE can measure this/these PRS and report the measurement result(s) to a network, e.g., a Location Management Function, LMF, in the Core Network, CN, 5G CN, 5GC.

In an embodiment, in the uplink (UL) as shown in FIG. 2, the SRS is transmitted by one UE. One or multiple gNBs (see above) may measure the SRS and report the measurement result(s) to the network (e.g., LMF).

However, the transmission of PRS and SRS for the purpose of positioning (localization) is easily affected by the radio propagation environment (e.g., fading, distortion). Hence, the positioning accuracy is limited.

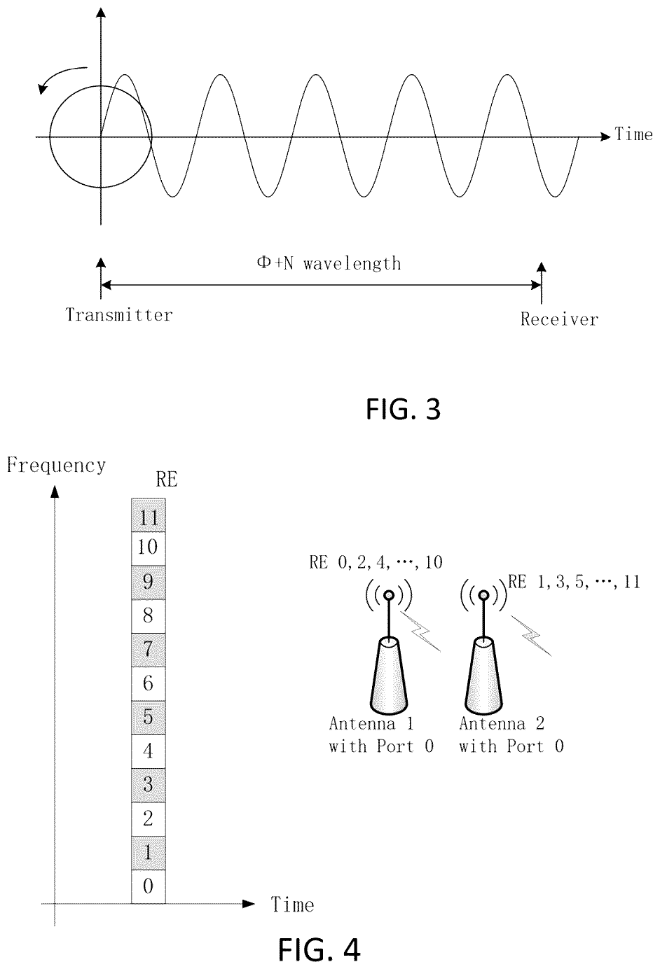

As shown in FIG. 3, a radio wave travels from a transmitter to a receiver with a multiple of the wavelength. For a full wavelength, the corresponding carrier phase (or, carrier phase difference between transmitter and receiver) is 2π. For a fraction of a wavelength, the corresponding carrier phase is a value within (0, 2π). If the carrier phase could be measured and assuming no noise interference, and a line of sight, LOS, between transmitter and receiver, the distance between transmitter and receiver (D) is

$$D = ( Φ + N ) \cdot λ = ( Φ + N ) \cdot c / f \qquad ( Equation 1 )$$

wherein Φ is the fraction part of the measured carrier phase, N is the integer part of the measured carrier phase, A is the wavelength of the radio wave transmitted by the transmitter, c is the velocity of light and f is the carrier frequency of the radio wave transmitted by the transmitter.

In other words, if a UE can measure the carrier phase (e.g., Φ, N or Φ+N), then the distance between transmitter and receiver can be determined.

According to an embodiment, in a real scenario, a radio wave travels in multiple paths between transmitter and receiver. There can be one LOS path between them. In some cases, there is no LOS path between them but there is/are one or multiple non-LOS (NLOS) paths between them. For different paths, the measured carrier phase may be different, i.e., the radio wave travels more or less on different paths.

This embodiment is described for DL-PRS. However, its principle can also be applied to UL-SRS.

First, a network (e.g., a LMF) will configure one or more carrier frequencies for a base station (e.g., gNB, it should be noted that a gNB is also a part of the network) and a UE for radio transmission/reception. Alternatively, the carrier frequency is expressed via an absolute radio frequency channel number (ARFCN). Alternatively, the carrier frequency is expressed via an offset to another carrier (e.g., UE's serving carrier, UE's serving cell). Alternatively, the carrier frequency is expressed via an offset to another carrier's ARFCN.

Alternatively, one carrier frequency carries a reference signal for positioning (e.g., PRS, SRS).

Second, a base station (e.g., gNB) transmits a reference signal for positioning (e.g., PRS). Alternatively, the base station transmits a PRS on one or multiple symbols. Alternatively, the base station transmits a PRS on one or multiple contiguous symbols (e.g., 4 contiguous symbols).

Alternatively, the base station transmits a PRS on multiple contiguous symbols (e.g., 8 contiguous symbols) with an identical sequence. Alternatively, the base station transmits a PRS on multiple contiguous symbols with a sequence with an identical initialization seed (c_init).

Alternatively, the base station transmits a PRS on multiple contiguous symbols with a sequence with an orthogonal cover code (OCC, e.g., +1 for the first sequence, −1 for the second sequence, +j for the third sequence, −j for the fourth sequence; in addition, the OCC can be the same length to that of the PRS sequence).

Alternatively, the PRS sequence is mapped to one or multiple contiguous symbols (e.g., 12 contiguous symbols). Alternatively, the PRS sequence is mapped to one or multiple contiguous symbols (e.g., 14 contiguous symbols, i.e., one slot) with identical sub-carrier. Alternatively, the PRS sequence is mapped to one or multiple contiguous symbols (e.g., 16 contiguous symbols) with identical starting sub-carrier. Alternatively, the PRS sequence is mapped to one or multiple contiguous symbols (e.g., 32 contiguous symbols) with identical starting sub-carrier and end sub-carrier.

Alternatively, the number of contiguous symbols is configured by the network (e.g., LMF). Alternatively, the number of contiguous symbols is associated with a requirement of positioning accuracy. For example, if the requirement of positioning accuracy is 0.2 m, then the number of contiguous symbols is 8. In another example, if the requirement of positioning accuracy is 0.15 m, then the number of contiguous symbols is 12.

Alternatively, the number of contiguous symbols is associated with a requirement of positioning accuracy and a bandwidth of reference signal for positioning. For example, if the requirement of positioning accuracy is 0.2 m and the bandwidth of PRS is 50 MHz, then the number of contiguous symbols is 8. In another example, if the requirement of positioning accuracy is 0.2 m and the bandwidth of PRS is 100 MHz, then the number of contiguous symbols is 4.

Alternatively, the gNB transmits a PRS on a transmission and reception point (TRP) with the same TEG. Alternatively, the gNB transmits a PRS on a TRP with the same transmission TEG (Tx TEG). Alternatively, the gNB transmits a PRS on a TRP with the same transmission-reception TEG (Tx-Rx TEG). Alternatively, the gNB transmits a PRS on a TRP with the same reception-transmission TEG (Rx-Tx TEG).

Alternatively, the gNB transmits a PRS on a TRP with the same TEG ID (e.g., 0-255). Alternatively, the gNB transmits a PRS on a TRP with the same Tx TEG ID (e.g., 0-31). Alternatively, the gNB transmits a PRS on a TRP with the same Tx-Rx TEG ID (e.g., 0-63). Alternatively, the gNB transmits a PRS on a TRP with the same Rx-Tx TEG ID (e.g., 0-128).

Third, a device to be located (e.g., UE) receives the reference signal for positioning (e.g., PRS). Alternatively, the UE receives a PRS on multiple contiguous symbols.

Alternatively, the UE combines PRS on multiple contiguous symbols. Alternatively, the UE combines PRS on multiple contiguous symbols at sample level (e.g., a combination on Ts=1/(15000*2048) seconds, a combination on Tc=Ts/64). With this method, the timing error between gNB and UE can be reduced. Hence, the positioning accuracy can be improved.

Alternatively, the UE receives a PRS with the same receiving beam. Alternatively, the UE receives a PRS with the same timing error group (TEG). Alternatively, the UE receives a PRS with the same receiving TEG (Rx TEG). Alternatively, the UE receives a PRS with the same receiving-transmission TEG (Rx-Tx TEG, or Tx-Rx TEG). Alternatively, the UE receives a PRS with the TEG requested by a LMF.

Alternatively, the UE receives a PRS with the same TEG ID (e.g., 0-255). Alternatively, the UE receives a PRS with the same Rx TEG ID (e.g., 0-31). Alternatively, the UE receives a PRS with the same Rx-Tx TEG ID (e.g., 0-63). Alternatively, the UE receives a PRS with the same Tx-Rx TEG ID (e.g., 0-127).

Fourth, a device to be located (e.g., UE) measures the reference signal for positioning (e.g., PRS). Alternatively, a UE measures a carrier phase (e.g., Φ and N as the following equation) of PRS. Alternatively, a UE measures a carrier phase of PRS on a radio propagation path (abbr., path). Alternatively, a UE measures a carrier phase of PRS on one or more paths. Alternatively, a UE measures a carrier phase of PRS on a path on the carrier center (or carrier center frequency).

Alternatively, a UE measures a carrier phase difference of PRS between itself and a gNB. Alternatively, the carrier phase difference (especially, the fractional part, Φ) can be from a phase lock loop (PLL) or digital phase lock loop (DLL). If there is no confusion introduced, the carrier phase difference can be referred as carrier phase.

Alternatively, a UE measures a carrier phase (e.g., Φ and N as the following equation) of a PRS on the first path to deduce its distance to a gNB (e.g., D and Noise as the following equation, wherein the Noise is a random value). Alternatively, a UE measures a carrier phase of a PRS on the first arrival path.

$$( {Φ}_{1} + {N}_{1} ) \cdot λ = {D}_{1} + {Noise}_{1} \qquad ( Equation 2 )$$

Alternatively, a UE measures a carrier phase (e.g., Φ and N as the following equation) of a PRS on the second path to deduce its distance to a gNB (e.g., D and Noise as the following equation, wherein Δt is a time difference between two paths. At may be known (predetermined) before a measurement (e.g., one Tc, wherein Tc=1/(15000*2048*64)=0.50863 ns). Alternatively, a UE measures a carrier phase of a PRS on the second arrival path.

$$( {Φ}_{2} + {N}_{2} ) \cdot λ = {D}_{2} + {Noise}_{2} = {D}_{1} + c \cdot Δ t + {Noise}_{2} \qquad ( Equation 3 )$$

Similarly, a UE measures a carrier phase of a PRS on the other path(s).

Subtracting Equation 3 from Equation 2 yields:

$$( {Φ}_{3} + {N}_{3} ) \cdot λ = c \cdot Δ t + {Noise}_{3} \qquad ( Equation 4 )$$

wherein Φ3=Φ₂−Φ₁ and N₃=N₂−N₁, if the random noises are close to each other or, the noise will be reduced. That is, the timing error between gNB and UE will be reduced. Thus, the positioning accuracy can be improved.

Adding Equation 3 to Equation 2 and then dividing by 2 at both sides results in

$$( {Φ}_{4} + {N}_{4} ) \cdot λ = {D}_{1} + c \cdot Δ t + {Noise}_{4} \qquad ( Equation 5 )$$

wherein Φ₄=(Φ₂+Φ₁)/2, N₄=(N₂+N₁)/2 and Noise₄=(Noise₂+Noise₁)/2, the noise will be averaged. The noise averaging will improve positioning accuracy.

Alternatively, a UE measures a carrier phase difference (e.g., Φ and N as the equation above) of a PRS between two (or more) carriers. Alternatively, a UE measures a carrier phase difference (e.g., Φ and N as the equation above) of a PRS between two (or more) PRS resources.

Alternatively, a UE measures a carrier phase difference (e.g., Φ and N as the equation above) of a PRS between two (or more) PRS resources on different TRPs.

Alternatively, a UE measures a carrier phase difference (e.g., Φ and N as the equation above) of a PRS between two (or more) PRS resources on the same Tx TEG.

Alternatively, a UE measures a carrier phase difference (e.g., Φ and N as the equation above) of a PRS between two (or more) PRS resources with the same Rx TEG.

Alternatively, a UE measures a carrier phase difference (e.g., Φ and N as the equation above) of a PRS between two (or more) PRS resources from different TRPs with the same Tx TEG.

Alternatively, a UE measures a carrier phase difference (e.g., Φ and N as the equation above) of a PRS between two (or more) PRS resources from different TRPs with the same Rx TEG.

Alternatively, a UE measures a carrier phase (e.g., Φ and N as the equation above) on cluster(s) of a PRS. Alternatively, a UE measures a carrier phase on arrival cluster(s) of a PRS. Alternatively, a cluster of signal has one or more rays of signal. Alternatively, a cluster of signal has one or more paths of signal.

Alternatively, a UE measures a carrier phase on ray(s) of PRS.

Alternatively, a UE measures a carrier phase difference (e.g., Φ and N as the equation above) on arrival clusters of PRS. Alternatively, a UE measures a carrier phase difference on rays of PRS.

Alternatively, a UE measures a carrier phase difference between arrival clusters of PRS. Alternatively, a UE measures a carrier phase difference between rays of PRS.

Alternatively, a UE measures a carrier phase difference between the first arrival cluster and other arrival cluster(s) of PRS. Alternatively, a UE measures a carrier phase difference between the first ray and other ray(s) of PRS.

Alternatively, a UE measures a carrier phase difference between the first ray of the first arrival cluster and other ray(s) of PRS.

Fifth, a device to be located (e.g., UE) reports measurement result(s) to the network (e.g., an LMF). Alternatively, a UE reports a carrier phase (or carrier phase difference) of PRS to LMF (e.g., integer part N, fractional part). Alternatively, a UE reports a carrier phase with corresponding ARFCN of the measured carrier. Alternatively, a UE reports a carrier phase of one or more paths (e.g., according to their arrival time). Alternatively, a UE reports a carrier phase of the first arrival path. Alternatively, a UE reports a carrier phase of other paths (besides the first arrival path). Alternatively, a UE reports a carrier phase of other paths in the additional report.

Alternatively, a UE reports a carrier phase difference between paths (e.g., integer part N₃, fractional part Φ3 in Equation 4). Alternatively, a UE reports a carrier phase difference between paths with an indication of path ID (e.g., ‘0’ and ‘1’ for the first path and second path).

Alternatively, a UE reports a carrier phase difference between carriers (or frequency layers, FL, a FL is a carrier) (e.g., integer part N3, fractional part Φ3 in Equation 4). Alternatively, a UE reports a carrier phase difference between carriers with indication of carrier ID (e.g., by means of ARFCN, or FL ID).

Alternatively, a UE reports an average carrier phase of carriers (or FL) (e.g., integer part N4, fractional part Φ4 in Equation 5).

Alternatively, a UE reports a carrier phase difference between PRS resources. Alternatively, a UE reports a carrier phase difference between PRS resources on the same symbol. Alternatively, a UE reports a carrier phase difference between PRS resources on the different symbols. Alternatively, a UE reports a carrier phase difference between PRS resources with indication of a PRS resource ID. Alternatively, a UE reports a carrier phase difference between PRS resources with indication of a PRS resource set ID. Alternatively, a UE reports a carrier phase with indication of a PRS set ID.

Alternatively, a UE reports a carrier phase of a transmission and reception point (TRP, e.g., gNB). Alternatively, a UE reports a carrier phase of a TRP with indication of a TRP ID (or, PRS ID/PRS resource ID).

Alternatively, a UE reports a carrier phase difference between transmission and reception points (TRP). Alternatively, a UE reports a carrier phase difference between TRP with indication of TRP ID (or, PRS ID).

Alternatively, a UE reports a carrier phase difference between a TRP and an assistance data reference TRP. Where the assistance data can come from a network (e.g., LMF). Alternatively, the assistance data reference TRP can be indicated by a network (e.g., LMF). Alternatively, the assistance data reference TRP can be indicated by a UE.

Alternatively, a UE reports a carrier phase difference between TRP on the same PRS resource. Alternatively, a UE reports a carrier phase difference between TRP on the same PRS resource on the same symbol. Alternatively, a UE reports a carrier phase difference between TRP on the same PRS resource with indication of TRP ID (or, PRS ID) and PRS resource ID.

Alternatively, a UE reports a carrier phase of a transmission point (TP, e.g., gNB). Alternatively, a UE reports a carrier phase of a TP with indication of TP ID (or, PRS ID).

Alternatively, a UE reports a carrier phase difference between transmission points (TPs, e.g., gNB). Alternatively, a UE reports a carrier phase difference between TPs with indication of TP IDs (or, PRS IDs).

Alternatively, a UE reports Q candidate(s) of carrier phase of PRS (e.g., Q is an integer, Q=2, alternatively, Q is configured by a network, e.g. an LMF). Alternatively, a UE reports Q candidate(s) of a carrier phase of a PRS on a path (e.g., Q=3). Alternatively, a UE reports Q candidate(s) of a carrier phase of a PRS on the first path (e.g., Q=4). Alternatively, a UE reports Q candidate(s) of a carrier phase of a PRS on a path other than the first path (e.g., Q=1).

Alternatively, a UE reports Q candidate(s) of a carrier phase of PRS (e.g., Q=2). For example, Q=2 integers (i.e., 2 values of integer part N) and Q=2 floats (i.e., 2 values of fractional part Φ) are reported. For another example, Q=3 integers (i.e., 3 values of integer part N) and one float (i.e., one value of fractional part Φ) are reported. For still another example, Q=4 integers (i.e., 4 values of integer part N) and one float corresponding to the first integer (i.e., one value of fractional part Φ) are reported. Furthermore, in another example, Q=5 integers (i.e., 5 values of integer part N) and one float with minimum value (i.e., one value of fractional part Φ) are reported.

Alternatively, a UE reports Q candidate(s) of a carrier phase difference of PRS (e.g., Q=2). Alternatively, a UE reports Q candidate(s) of a carrier phase difference of PRS on a path (e.g., Q=3). Alternatively, a UE reports Q candidate(s) of a carrier phase difference of PRS on the first path (e.g., Q=4). Alternatively, a UE reports Q candidate(s) of a carrier phase difference of PRS on a path other than the first path (e.g., Q=6).

Alternatively, a UE reports Q candidate(s) of a carrier phase difference of PRS (e.g., Q=2). For example, Q=2 integers (i.e., 2 values of integer part N) and Q=2 floats (i.e., 2 values of fractional part Φ) are reported. Alternatively, a UE reports Q candidate(s) of a carrier phase difference of PRS (e.g., Q=2). For example, Q=2 integers (i.e., 2 values of integer part N) and corresponding Q=2 floats (i.e., 2 values of fractional part Φ) are reported.

Alternatively, a UE reports Q pair(s) carrier phase of PRS (e.g., Q=2 pairs of integer part N and fractional part Φ). Alternatively, a UE reports Q pair(s) candidate of a carrier phase of PRS (e.g., Q=3 pairs of integer part N and fractional part Φ).

Alternatively, a UE reports Q pair(s) a carrier phase difference of PRS (e.g., Q=2 pairs of integer part N and fractional part Φ). Alternatively, a UE reports Q pair(s) candidate of a carrier phase difference of PRS (e.g., Q=3 pairs of integer part N and fractional part Φ).

Alternatively, a UE reports a carrier phase of a PRS on arrival cluster(s). Alternatively, a UE reports a carrier phase of a PRS on arrival cluster(s) with indication of time lag (e.g., the time lag of the first arrival cluster is 0, the time lag of the second arrival cluster is 0.2 ns).

Alternatively, a UE reports a carrier phase difference of PRS on arrival cluster(s). Alternatively, a UE reports a carrier phase difference of PRS between the first arrival cluster and the other arrival cluster(s).

Alternatively, if the reception power of a ray is high enough (e.g., greater than a threshold, e.g., −140 dBm), then a UE may report a carrier phase of this ray. Alternatively, if the reception power of a ray is high enough, then a UE may report a carrier phase of this ray with indication of time lag (e.g., relative to the first ray of the first arrival cluster).

Alternatively, if the reception power of a path is high enough (e.g., greater than a threshold, e.g., −142 dBm), then a UE may report a carrier phase of this path. Alternatively, if the reception power of a path is high enough, then a UE may report a carrier phase of this path with indication of time lag (e.g., relative to the first path).

Alternatively, if the reception power of a path is high enough (e.g., greater than a threshold, e.g., −142 dBm), then a UE may report a carrier phase difference of this path. Alternatively, if the reception power of a path is high enough, then a UE may report a carrier phase difference of this path with indication of time lag (e.g., relative to the first path).

Sixth, the network (e.g., a LMF) calculates the position of the device to be located (e.g., UE).

With this method, the positioning accuracy can be improved.

Next, another embodiment is described for UL-SRS. However, its principle can also be applied to DL-PRS.

First, a network (e.g., a LMF) configures a base station (and a device to be located) to perform an operation of uplink positioning.

Second, a base station requests (or configures) a device to be located to transmit a reference signal for positioning.

Third, a device to be located transmits a reference signal for positioning (e.g., SRS). Alternatively, the SRS is required (e.g., by a LMF) to be transmitted with the same transmission TEG (Tx TEG). Alternatively, the SRS within a resource group is required to be transmitted with the same Tx TEG. Alternatively, the SRS within a SRS resource group is required to be transmitted with the same Tx TEG. Alternatively, the SRS within a SRS resource group is transmitted with the same Tx TEG. Alternatively, the SRS within a SRS resource set is required to be transmitted with the same Tx TEG.

Alternatively, the UE transmits a SRS with the same TEG ID (e.g., 0-255). Alternatively, the UE transmits a SRS with the same Tx TEG ID (e.g., 0-31). Alternatively, the UE transmits SRS with the same Rx-Tx TEG ID (e.g., 0-63). Alternatively, the UE transmits SRS with the same Tx-Rx TEG ID (e.g., 0-127).

Fourth, a base station receives a reference signal for positioning (e.g., SRS) from a device to be located. Alternatively, the SRS is required (e.g., by a LMF) to be received with the same Rx TEG. Alternatively, the SRS within a resource group is required (e.g., by a LMF) to be received with the same Rx TEG. Alternatively, the SRS within a resource group is received with the same Rx TEG (e.g., the same SRS resource ID, the same SRS resource group ID, the same SRS resource set ID). Alternatively, the SRS within a resource group is received with the same Rx TEG (e.g., the same TRP).

Fifth, a base station measures a reference signal for positioning (e.g., SRS) from a device to be located. Alternatively, a gNB measures a carrier phase of an SRS. Alternatively, a gNB measures a carrier phase of a SRS on one or more paths. Alternatively, a gNB measures a carrier phase of a SRS on the first arrival path. Alternatively, a gNB measures a carrier phase of a SRS on other path(s) (except the first arrival path) as additional measurement(s) (e.g., 3 or 7 additional measurements, i.e., 4 or 8 measurement results in total).

Sixth, a base station reports measurement result(s) of a reference signal for positioning (e.g., SRS) to a network (e.g., a LMF). Alternatively, a gNB reports a carrier phase of a SRS. Alternatively, a gNB reports a carrier phase of a SRS on one or more paths. Alternatively, a gNB reports a carrier phase difference of a SRS between paths.

Seventh, the network (e.g., a LMF) calculates the position of the device to be located (e.g., UE).

With this method, the uplink positioning accuracy can be improved.

In an embodiment, a network (e.g., a LMF) will first configure one or more carrier frequencies for a base station (e.g., gNB, it should be noted that a gNB is also a part of network) and a UE for radio transmission/reception.

Second, a base station (e.g., gNB) transmits a reference signal for positioning (e.g., PRS).

Third, a device to be located (e.g., UE) receives the reference signal for positioning (e.g., PRS).

Fourth, a device to be located (e.g., UE) measures the reference signal for positioning (e.g., PRS). Alternatively, a UE calculates a LOS/NLOS probability when measuring a PRS. Alternatively, a UE calculates a LOS/NLOS probability when measuring a carrier phase of a PRS. Alternatively, a UE calculates a LOS/NLOS probability when measuring a carrier phase of a PRS on one or more paths. Alternatively, a UE calculates a LOS/NLOS probability when measuring a carrier phase of a PRS on the first arrival path. Alternatively, a UE calculates a LOS/NLOS probability when measuring a carrier phase of a PRS on the path with the highest reception power.

Alternatively, a UE calculates a LOS/NLOS probability with a confidence level (e.g, 95%) when measuring a carrier phase of a PRS. Alternatively, a UE calculates a LOS/NLOS probability with a confidence level (e.g, 99%) when measuring a carrier phase of a PRS on the first arrival path. Alternatively, the confidence level is configured by the network (e.g., LMF).

Fifth, a device to be located (e.g., UE) reports measurement result(s) to the network (e.g., a LMF). Alternatively, a UE reports a carrier phase of a PRS with an indication of a LOS/NLOS. Alternatively, a UE will not report a carrier phase of a PRS if the probability of a NLOS is too high. Alternatively, a UE will not report a carrier phase of a PRS if the probability of a NLOS exceeds a threshold (e.g., 20%). Alternatively, a report of a carrier phase of a PRS will be absent if the probability of NLOS exceeds a threshold (e.g., 15%). Alternatively, the threshold of probability of LOS/NLOS is configured by a higher layer (or, network, e.g., LMF). Alternatively, the threshold of probability of LOS/NLOS is configured by a long term evolution (LTE) positioning protocol (LPP) layer (LPP layer, in a LMF).

Alternatively, a report of a carrier phase of a PRS on the first arrival path is with a precise (or, fine) granularity (e.g., one degree, half degree, π/180, π/360, 8 bits report, 9 bits report). Alternatively, a report of a carrier phase of a PRS on the other path is with a coarse granularity (e.g., 10 degree, π/18, 4 bits report, 5 bits report). Alternatively, an additional report of a carrier phase of PRS is with a coarse granularity. Alternatively, an additional report includes reports of result(s) on other paths different from the first arrival path. Alternatively, a report with fine granularity includes reports of measurement result(s) on the first arrival path. Alternatively, a basic report with fine granularity includes reports of measurement result(s) on the first arrival path.

Alternatively, a report of measurement result(s) on the first arrival path is with fine granularity (e.g., one degree, half degree, π/180, π/360, 8 bits report, 9 bits report). Alternatively, a report of measurement result(s) on other paths is with coarse granularity. Alternatively, an additional report of measurement result(s) is with coarse granularity.

Alternatively, a reason for an error report can be a NLOS probability that is too high (or a LOS probability that is too low).

Alternatively, a UE reports a carrier phase of a PRS on the path with the highest reception power. Alternatively, a UE reports a carrier phase of PRS on the path with the highest reception power with an indication of LOS/NLOS.

Alternatively, a UE reports a carrier phase of a PRS with an indication of LOS/NLOS with a confidence level (e.g., 95.5%). Alternatively, a UE reports a carrier phase of a PRS on the first path with an indication of LOS/NLOS with a confidence level. Alternatively, a UE reports a carrier phase difference of PRS with an indication of LOS/NLOS with a confidence level.

Alternatively, a UE reports a carrier phase difference of a PRS with a linkage between carriers. Alternatively, a UE reports a carrier phase difference of PRS with a linkage recommendation between carriers.

Sixth, the network (e.g., a LMF) calculates the position of the device to be located (e.g., UE). Alternatively, a LMF calculates the position of UE with a carrier phase (or carrier phase difference) with a linkage between carriers. Alternatively, a LMF calculates the position of a UE with a carrier phase (or carrier phase difference) with re-linking the linkage between carriers.

With this method, the positioning accuracy can be improved.

In an embodiment, a network (e.g., a LMF) will first configure one or more carrier frequencies for a base station (e.g., gNB, it should be noted that a gNB is also a part of the network) and a UE for radio transmission/reception.

Second, a base station (e.g., gNB) transmits a reference signal for positioning (e.g., PRS).

Third, a device to be located (e.g., UE) receives the reference signal for positioning (e.g., PRS).

Fourth, a device to be located (e.g., UE) measures the reference signal for positioning (e.g., PRS). Alternatively, a UE computes a signal to noise ratio (SNR) or a signal to interference plus noise ratio (SINR) of a PRS when measuring carrier phase of PRS. Alternatively, a UE computes a SNR/SINR of a PRS on the first arrival path when measuring a carrier phase of a PRS. Alternatively, a UE computes a SNR/SINR of a PRS on other path(s) except the first arrival path when measuring a carrier phase of a PRS.

Alternatively, a UE computes a reference signal received power (RSRP) and/or reference signal received quality (RSRQ) of a PRS when measuring a carrier phase of PRS. Alternatively, a UE computes a RSRP and/or a RSRQ of a PRS on the first arrival path when measuring a carrier phase of a PRS.

Fifth, a device to be located (e.g., UE) reports measurement result(s) to the network (e.g., a LMF). Alternatively, a UE reports a carrier phase of a PRS with at least one indication of SNR, SINR, RSRP, RSRQ. Alternatively, a UE reports a carrier phase of a PRS on the first arrival path with at least one indication of SNR, SINR, RSRP, or RSRQ.

Alternatively, a UE reports an integer part of a carrier phase (i.e., N) with X bits (e.g., X=12). Alternatively, a UE reports a fraction part of carrier phase (i.e., Φ) with Y bits (e.g., Y≥7, Y=10). Alternatively, a UE reports an integer part of a carrier phase difference (i.e., N) with X bits. Alternatively, a UE reports a fraction part of a carrier phase difference (i.e., Φ) with Y bits. Alternatively, X≥Y. Alternatively, X+Y≤10.

Alternatively, a UE reports a carrier phase difference of a PRS with at least one indication of SNR, SINR, RSRP, or RSRQ. Alternatively, a UE reports a carrier phase difference of PRS between carriers with at least one indication of SNR, SINR, RSRP, or RSRQ.

Alternatively, a UE reports a carrier phase difference of a PRS between carriers on respective center frequencies with at least one indication of SNR, SINR, RSRP, or RSRQ. With this indication, a low reliable report (e.g., a low SNR report) can be avoided.

Alternatively, a UE reports a carrier phase difference of a PRS between carriers with PRS set ID (or PRS ID, or PRS resource ID). Alternatively, a UE reports a carrier phase difference of a PRS between carriers on a base of per-resource.

Alternatively, a UE reports a carrier phase of a PRS on a base of per-resource.

Alternatively, a UE reports a carrier phase difference of a PRS between PRS resource with PRS set ID (or PRS ID, or PRS resource ID).

Alternatively, a UE reports a carrier phase difference of a PRS with a linkage of carriers/FL (e.g., the first FL and the third FL).

Alternatively, a differential report is applied for a carrier phase report. Alternatively, a differential report is applied for an additional report of carrier phase report. For example, if the carrier phase for the first arrival path of PRS is W, the carrier phase for the second arrival path of PRS is V, the carrier phase for the third arrival path of PRS is Z, then a UE should report W for the first arrival path, V-W for the second arrival path in the additional report, Z-W for the third arrival path in the additional report.

Alternatively, a differential value of a carrier phase which is reported is relative to that of the first arrival path.

Alternatively, a differential report is with a link between one frequency layer and reference frequency layer. Alternatively, a reference frequency layer is with a lowest carrier ID. Alternatively, a reference frequency layer is with a highest carrier frequency.

Alternatively, a report is based on per reference signal for a positioning resource (per PRS resource report, e.g., reporting measurement results on the same PRS resource from multiple TRP).

Sixth, the network (e.g., a LMF) calculates the position of the device to be located (e.g., UE). Alternatively, a LMF can calculate the position of UE according to a linkage of carriers/FL. For example, a LMF can calculate the position of UE based on the carrier phase difference of PRS between the first FL and the 4th FL (because these two FL are linked).

With this method, the positioning accuracy can be improved.

In an embodiment, for carrier phase measurement, a phase-contiguous signal (e.g., a sine wave) is helpful for UE measuring. However, the signal of current PRS/SRS is non-phase-contiguous. As a result of that, signal design for PRS/SRS may be considered.

Before adding a cyclic prefix (CP) of an orthogonal frequency divided multiplexing (OFDM) signal Xᵢ, i=0, 1, 2, . . . , M−1, where M is a power of 2, if the phase of each sample is Ψᵢ, then the phase of the second sample is Ψᵢ, and, the phase of the last sample of CP is Ψ_{M-1}. For each sample of CP, a phase shift is applied as follows:

$${Y}_{k} = ‖ {X}_{M - {N}_{CP} + k} ‖ \cdot exp ( - j \cdot ( {Ψ}_{1} + {Ψ}_{M - 1} ) ) , \\ k = 0 , 1 , 2 , … , {N}_{CP} - 1 \qquad ( Equation 6 )$$

wherein NCP is the number of samples of CP, an operation of ∥•∥ is an abstract of a complex (i.e., magnitude).

Alternatively, the following can be used to generate samples of CP:

$${Y}_{{N}_{CP} - k - 1} = ‖ {X}_{k + 1} ‖ \cdot exp ( - j \cdot angle ( {X}_{k} ) ) , \\ k = 0 , 1 , 2 , … , {N}_{CP} - 1 \qquad ( Equation 7 )$$

wherein the angle(•) will fetch the angle of a complex.

Alternatively, the receiver (e.g., UE) can also use the equations above (e.g., Equation 6) when measuring the carrier phase of PRS.

With this method, the positioning accuracy can be improved.

In an embodiment, a network (e.g., a LMF) will first configure one or more carrier frequencies for a base station (e.g., gNB, it should be noted that a gNB is also a part of the network) and a UE for radio transmission/reception.

Second, a base station (e.g., gNB) transmits a reference signal for positioning (e.g., PRS).

Third, a device to be located (e.g., UE) receives the reference signal for positioning (e.g., PRS).

Fourth, a device to be located (e.g., UE) measures the reference signal for positioning (e.g., PRS) as shown in Equation 2. Another equivalent form of Equation 2 is as follows:

$$Φ + N = ( D + Noise ) / λ = E + NNoise \qquad ( Equation 8 )$$

Therein, E is the distance between the gNB and the UE in unit of wavelength, NNoise is still a noise (i.e., a random value).

Usually, a UE can perform multiple measurements. Hence, Φ, N, E and Noise can be a vector (e.g., with 4 elements or more).

For multiple measurements of Φ and N, the elements are co-related to each other. Hence, a de-correlation operation can be performed on both sides of Equation 8, optionally (i.e., not necessarily). This operation can improve the accuracy of measurements. It should be noted that the noise is not co-related to each other (on multiple measurements).

Alternatively, a de-correlation operation is performed on the integer part (i.e., N) as follows:

$$M = P \cdot N \qquad ( Equation 9 )$$

wherein P is a transformation of a variance/covariance matrix.

Alternatively, a de-correlation operation is performed on the fraction part (i.e., Φ) as follows:

$$F = H \cdot Φ \qquad ( Equation 10 )$$

wherein H is a transformation of variance/covariance matrix.

With multiple measurements, a “best” integer can be found for N (e.g., via least mean square estimation). Alternatively, Q “best” and sub-optimal candidate(s) integer can be found for N. After that, the corresponding “best” and/or sub-optimal candidate(s) fraction value can be determined. That is, one or more pairs of integer and fraction can be determined.

With multiple measurements, a “best” integer can be found for M (e.g., via least mean square estimation). Alternatively, Q “best” and sub-optimal candidate(s) integer can be found for M. After that, the corresponding “best” and/or sub-optimal candidate(s) fraction value can be determined. That is, one or more pairs of integer and fraction after de-correlation can be determined. That is, one or more pairs of integer and fraction after de-correlation and optimal estimation can be determined.

After a pair of integer part and fraction part being determined, the distance between gNB and UE (i.e., E in Equation 8) can also be determined.

Fifth, a device to be located (e.g., UE) reports measurement result(s) to the network (e.g., a LMF). Alternatively, a UE reports Q pair(s) candidate of a carrier phase of a PRS (e.g., one “best” and Q−1 sub-optimal candidate(s) integer, with one “best” and Q−1 sub-optimal candidate(s) fraction). Alternatively, a UE reports Q pair(s) candidate of a carrier phase difference of a PRS (e.g., one “best” and Q−1 sub-optimal candidate(s) integer, with one “best” and Q−1 sub-optimal candidate(s) fraction).

Alternatively, a UE reports Q pair(s) candidate of a carrier phase of a PRS (e.g., one “best” and Q−1 sub-optimal candidate(s) integer, with one “best” and Q−1 sub-optimal candidate(s) fraction) after de-correlation. Alternatively, a UE reports Q pair(s) candidate of a carrier phase of a PRS (e.g., one “best” and Q−1 sub-optimal candidate(s) integer, with one “best” and Q−1 sub-optimal candidate(s) fraction) after de-correlation and optimal estimation.

Alternatively, a UE reports Q pair(s) candidate of a carrier phase difference of a PRS (e.g., one “best” and Q−1 sub-optimal candidate(s) integer, with one “best” and Q−1 sub-optimal candidate(s) fraction) after de-correlation. Alternatively, a UE reports Q pair(s) candidate of a carrier phase difference of a PRS (e.g., one “best” and Q−1 sub-optimal candidate(s) integer, with one “best” and Q−1 sub-optimal candidate(s) fraction) after de-correlation and optimal estimation.

Alternatively, a UE reports the distance between gNB and UE (i.e., E in Equ. 8) after de-correlation. Alternatively, a UE reports the distance between gNB and UE (i.e., E in Equ. 8) after de-correlation and optimal estimation (e.g., with least mean square).

Sixth, the network (e.g., a LMF) calculates the position of the device to be located (e.g., UE).

With this method, the positioning accuracy can be improved.

In an embodiment, a network (e.g., a LMF) will first configure one or more carrier frequencies for a base station (e.g., gNB, it should be noted that a gNB is also a part of the network) and UE for radio transmission/reception.

Second, a base station (e.g., gNB) transmits a reference signal for positioning (e.g., PRS).

Third, a device to be located (e.g., UE) receives the reference signal for positioning (e.g., PRS).

Fourth, a device to be located (e.g., UE) measures the reference signal for positioning (e.g., PRS). Alternatively, a UE measures its gesture with PRS. Alternatively, a UE measures its gesture with one or more antennas. Alternatively, a UE measures its gesture with PRS on one or more antennas. Alternatively, a UE measures its gesture with one or more panels. Alternatively, a UE measures its gesture with PRS. Alternatively, a UE measures its gesture with a TEG. Alternatively, a UE measures its gesture with identical TEG. Alternatively, a UE measures its gesture with identical Rx TEG. Alternatively, a UE measures its gesture with identical Rx-Tx TEG. Alternatively, a UE measures its gesture with identical Tx-Rx TEG.

Alternatively, a UE measures its gesture with multiple antennas. Alternatively, a UE measures its gesture with multiple panels. Alternatively, a UE measures its gesture with multiple TEG.

Alternatively, a UE measures its gesture with multiple antennas which are not all in one plane. Alternatively, a UE measures its gesture with multiple panels which are not all in one plane. Alternatively, a UE measures its gesture with multiple TEG which are not all in one plane.

Alternatively, a gesture is with one or more angles. Alternatively, a gesture is with one or more angle directions. Alternatively, a gesture is with 3 angle directions (e.g., X direction angle, Y direction angle, Z direction angle in a 3-dimension coordinates).

Fifth, a device to be located (e.g., UE) reports measurement result(s) to the network (e.g., a LMF). Alternatively, a UE reports its gesture (e.g., 3 direction angles in 3-dimensional coordinates). Alternatively, a UE reports its gesture with multiple TEG which are not all in one plane. Alternatively, a UE reports its gesture with multiple TEG which at least one antenna is in a plane different from that of other antennas.

Alternatively, a UE reports its gesture with a carrier phase of a PRS (e.g., integer part, fraction part). Alternatively, a UE reports its gesture with a carrier phase difference of a PRS (e.g., integer part, fraction part).

Alternatively, a report of gesture is absent if all the antennas of the UE are in one plane. Alternatively, a reason for failure of measurement (or report) is that all the antennas of UE are in one plane.

Alternatively, a report of gesture is absent if all the TEG of the UE are in one plane. Alternatively, a report of gesture is absent if all the Rx TEG of the UE are in one plane. Alternatively, a report of gesture is absent if all the Rx-Tx TEG of the UE are in one plane. Alternatively, a report of gesture is absent if all the Tx-Rx TEG of the UE are in one plane.

Alternatively, a report of angle (e.g., angle of departure, AoD, angle of arrival, AoA) is absent if all the antennas of the UE are in one plane.

Alternatively, a UE reports its gesture with an indication of which coordinate is applied (e.g., Local Coordinate System, LCS, or, Global Coordinate System, GCS).

Sixth, the network (e.g., a LMF) calculates the position of the device to be located (e.g., UE).

With this method, the positioning accuracy can be improved.

In an embodiment, a network (e.g., a LMF) will first configure one or more carrier frequencies for a base station (e.g., gNB, it should be noted that a gNB is also a part of the network) and a UE for radio transmission/reception.

Second, a base station (e.g., gNB) transmits reference signal for positioning (e.g., PRS). Alternatively, a gNB transmits two (or more) PRS on different PRS resources as in FIG. 4. In FIG. 4, the first PRS is transmitted on resource element (RE) 0, 2, 4, . . . , 10 on a resource block (i.e., the first PRS resource, e.g., with a resource 0, on one symbol) and the second PRS is transmitted on RE 1, 3, 5, . . . , 11 on a resource block (i.e., the second PRS resource, e.g., with a resource 1, on one symbol). Alternatively, the first PRS is transmitted on the first PRS resource with an antenna. Alternatively, the second PRS is transmitted on the second PRS resource with another antenna. Alternatively, the first PRS is transmitted on the first PRS resource with an antenna port (e.g., port 0). Alternatively, the second PRS is transmitted on the second PRS resource with an antenna port (e.g., an identical port, i.e., port 0). Alternatively, the second PRS is transmitted on the second PRS resource with an antenna port (e.g., an identical port, i.e., port 0) on a different antenna. Alternatively, the second PRS is transmitted on the second PRS resource with an antenna port (e.g., an identical port, i.e., port 0) on an identical antenna.

Alternatively, a gNB transmits two (or more) PRS on different PRS resources with the identical Tx TEG. Alternatively, a gNB transmits two (or more) PRS on different PRS resources with the identical Tx-Rx TEG. Alternatively, a gNB transmits two (or more) PRS on different PRS resources with the identical Rx-Tx TEG.

Third, a device to be located (e.g., UE) receives the reference signal for positioning (e.g., PRS).

Fourth, a device to be located (e.g., UE) measures the reference signal for positioning (e.g., PRS). Alternatively, a UE measures a carrier phase (difference) on different PRS resources (e.g., a carrier phase difference between RE 0 and RE 1). Alternatively, a UE measures a carrier phase (difference) with different PRS resources ID. Alternatively, a UE measures a carrier phase (difference) with different PRS resources set ID.

Alternatively, a UE measures a carrier phase (difference) on different PRS resources with the identical Rx TEG. Alternatively, a UE measures a carrier phase (difference) on different PRS resources with the identical Rx-Tx TEG. Alternatively, a UE measures a carrier phase (difference) on different PRS resources with the identical Tx-Rx TEG.

Alternatively, a UE measures angle of PRS when a PRS arrives. Alternatively, a UE measures an angle of departure (AoD) on different PRS resources. Alternatively, a UE measures an angle of departure (AoD) on different PRS resources from different antennas. Alternatively, a UE measures an angle of departure (AoD) on different PRS resources from different antenna ports. Alternatively, a UE measures an angle of departure (AoD) on different PRS resources from an identical antenna port. Alternatively, a UE measures an AoD on different PRS resources with the identical Rx TEG.

Alternatively, a UE measures an angle of a PRS with a carrier phase (difference). Alternatively, a UE measures an angle of a PRS with a carrier phase (difference) when a PRS arrives. Alternatively, a UE measures an AoD of a PRS with a carrier phase (difference) when a PRS arrives.

Fifth, a device to be located (e.g., UE) reports measurement result(s) to the network (e.g., a LMF). Alternatively, a UE reports a carrier phase (difference) on different PRS resources (e.g., carrier phase difference between RE 0 and RE 1). Alternatively, a UE reports a carrier phase (difference) with PRS resources ID. Alternatively, a UE reports a carrier phase (difference) with PRS resources set ID.

Alternatively, a UE reports a carrier phase (difference) with a PRS resources ID and an antenna port ID. Alternatively, a UE reports a carrier phase (difference) with a PRS resources set ID and an antenna port ID.

Alternatively, a UE reports a carrier phase (difference) with a PRS resources ID (e.g., 0, 1), an antenna port ID (e.g., 5000), and a TEG ID (e.g., 0-7). Alternatively, a UE reports a carrier phase (difference) with a PRS resources ID, an antenna port ID, and a Rx TEG ID. Alternatively, a UE reports a carrier phase (difference) with a PRS resources set ID, an antenna port ID, and a Rx-Tx TEG ID.

Sixth, the network (e.g., a LMF) calculates the position of the device to be located (e.g., UE).

With this method, the positioning accuracy can be improved.

In an embodiment, a network (e.g., a LMF) will first configure one or more carrier frequencies for a base station (e.g., gNB, it should be noted that a gNB is also a part of the network) and a UE for radio transmission/reception.

Second, a base station (e.g., gNB) transmits a reference signal for positioning (e.g., PRS).

Third, a device to be located (e.g., UE) receives the reference signal for positioning (e.g., PRS).

Fourth, a device to be located (e.g., UE) processes the reference signal for positioning (including measurement on the signal). Alternatively, in frequency domain, a channel impulse response (CIR) is reached after dividing the received signal (R) by a local copy of the transmitted signal (T) (e.g., CIR=R/T). A carrier phase can be achieved from CIR (in frequency domain). Alternatively, with inverse Fourier transformation, a version of a CIR in time domain can be achieved. In time domain, a carrier phase can be achieved from a CIR (in time domain, e.g., Φ=2πf*Δt, where f is the carrier center frequency, Δt is the time lag of CIR in time domain). It should be noted that this kind of carrier phase can be referred to as a carrier phase difference (between a transmitter and a receiver).

Fifth, a device to be located (e.g., UE) reports measurement result(s) to the network (e.g., a LMF). Alternatively, a UE reports the carrier phase above. Alternatively, a UE reports the carrier phase after channel impulse response. Alternatively, a UE reports the carrier phase based on a channel impulse response. Alternatively, a UE reports the carrier phase on a carrier center frequency. Alternatively, a UE reports the carrier phase on a carrier center frequency based on a channel impulse response. Alternatively, a UE reports the carrier phase of the first arrival path on a carrier center frequency based on a channel impulse response.

Sixth, the network (e.g., a LMF) calculates the position of the device to be located (e.g., UE).

With this method, the positioning accuracy can be improved.

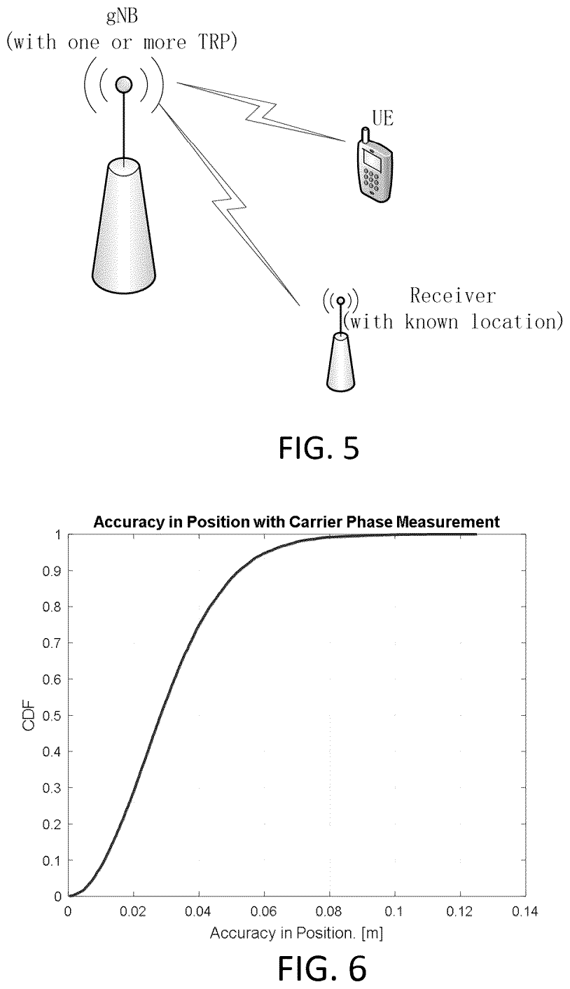

In an embodiment, a receiver with a known location (e.g., a Customer Premise Equipment, CPE, or a UE with a fixed position, or a base station that can receive a signal/channel from another base station) is introduced to assist positioning for a moving device (e.g., a UE) as shown in FIG. 5.

In addition, this receiver with a known location can also be a moving device (e.g., a UE with a GPS receiver). This UE can announce its GPS coordinates. Hence, its location can also be known.

Furthermore, this receiver with a known location can have good synchronization with a base station (e.g., zero delay, near-zero delay or a known/fixed delay).

First, a network (e.g., a LMF) will configure one or more carrier frequencies for a base station (e.g., gNB, it should be noted that a gNB is also a part of the network) and a receiver with known location for radio transmission/reception. Alternatively, a network (e.g., a LMF or gNB) configures the number of times that a measurement should be performed before reporting a measurement result of a carrier phase. For example, before reporting a measurement result of Φ (and/or N, as described above), X=10 times measurement of a carrier phase should be performed. For another example, before reporting a measurement result of Φ (and/or N, as described above), X=20 time slots should be measured on a carrier phase wherein each slot contains one measurement result. For still another example, before reporting a measurement result of Φ (and/or N, as described above), X=30 PRS resources should be measured on a carrier phase wherein one measurement result comes from each PRS resource. For still another example, before reporting a measurement result of Φ (and/or N, as described above), X=10 TRP should be measured on a carrier phase wherein one measurement result comes from each TRP. For another example, before reporting a measurement result of Φ (and/or N, as described above), Z=X*Y times should be measured on a carrier phase where X is the number of time slots and Y is the number of PRS resources.

Second, a base station (e.g., gNB) transmits a reference signal for positioning (e.g., PRS).

Third, a device to be located (e.g., UE) receives the reference signal for positioning (e.g., PRS). At the same time, a receiver with known location also receives the reference signal for positioning (e.g., PRS).

Fourth, a device to be located (e.g., UE) and a receiver with known location measure the reference signal for positioning (e.g., PRS). Alternatively, there is a reference point when a UE measures a carrier phase (or carrier phase difference) of PRS. Alternatively, the reference point can be a carrier (or frequency layer, FL, or, positioning frequency layer, PFL) (e.g., a carrier with a lowest ARFCN). Alternatively, the reference point can be a PRS resource (e.g., a PRS resource with a resource ID of zero, i.e., ID=0). Alternatively, the reference point can be a TRP (e.g., a TRP with TRP ID=0).

Fifth, a device to be located (e.g., UE) reports measurement result(s) to the network (e.g., a LMF). Alternatively, a receiver with known location reports measurement result(s) to the network (e.g., a LMF). Alternatively, a UE (e.g., a receiver with known location reports) reports carrier phase of PRS (e.g., Φ and N as the equation above). Alternatively, a UE (e.g., a receiver with known location reports) reports a carrier phase of PRS (e.g., Φ and N as the equation above) with its location (e.g., GPS coordinates, or geographic coordinates). Alternatively, a UE (e.g., a receiver with known location reports) reports a carrier phase of PRS (e.g., Φ and N as the equation above) with its location indication (e.g., station ID, or UE ID). Alternatively, a base station (e.g., a receiver with known location reports) reports a carrier phase of PRS (e.g., Φ and N as the equation above) with its location indication (e.g., station ID, or UE ID).

Alternatively, a UE (e.g., a receiver with known location reports) reports a carrier phase of PRS (e.g., Φ and N as the equation above) with its measurement time (or number) indication (e.g., symbol ID, slot ID, frame ID, system frame ID, SFN, or GPS time).

Alternatively, a UE reports a carrier phase of PRS (e.g., Φ and N as the equation above) with distance information which distance is the distance between gNB and UE. The distance information can be used to determine phase information (e.g., modified Φ and/or modified N). Alternatively, a UE reports carrier phase of PRS with time of arrival (TOA) information (e.g., time lag between gNB and UE, time lag between transmitter and receiver). Alternatively, a UE reports a carrier phase of PRS with time difference of arrival (TDOA) information.

Alternatively, a UE reports a carrier phase of PRS with distance information of the first arrival path. Alternatively, a UE reports a carrier phase of PRS with TOA information of the first arrival path. Alternatively, a UE reports a carrier phase of PRS with TDOA information of the first arrival path.

Alternatively, a UE reports a carrier phase difference of a PRS with distance information of the first arrival path. Alternatively, a UE reports a carrier phase difference of a PRS with TOA information of the first arrival path. Alternatively, a UE reports a carrier phase difference of a PRS with TDOA information of the first arrival path. Alternatively, the carrier phase difference can be the difference between the phase of carrier generated in local and the phase of the received carrier (or signal).

Alternatively, a UE reports a carrier phase of a PRS with distance information of the first arrival path and/or the second arrival path.

Alternatively, a UE reports a carrier phase (e.g., Φ and/or N, as described above) of a PRS after a deduction from a number of measurements. For example, a UE reports a carrier phase after a least square (LS) method on X=10 measurement results.

Alternatively, a UE reports a carrier phase of a PRS with an indication of the number of measurement (e.g., with an information of X=10 measurements).

Alternatively, a UE reports a carrier phase of a PRS with an indication of the reference point (e.g., a PFL ID, a PRS resource ID).

Sixth, the network (e.g., a LMF) calculates the position of the device to be located (e.g., UE). For example, a LMF can perform a differential operation between the carrier phase from a UE to be located and the carrier phase from a receiver with known location.

With this method, the positioning accuracy can be improved as shown in FIG. 6 (Note: for a traditional TOA positioning, the positioning accuracy is about 0.44 m which cannot fulfil a requirement of 0.2 m. But this method can achieve a positioning accuracy of 0.052 m@CDF=90%, with 4 base stations used for positioning). In addition, the positioning system can also be calibrated (with known location of UE).

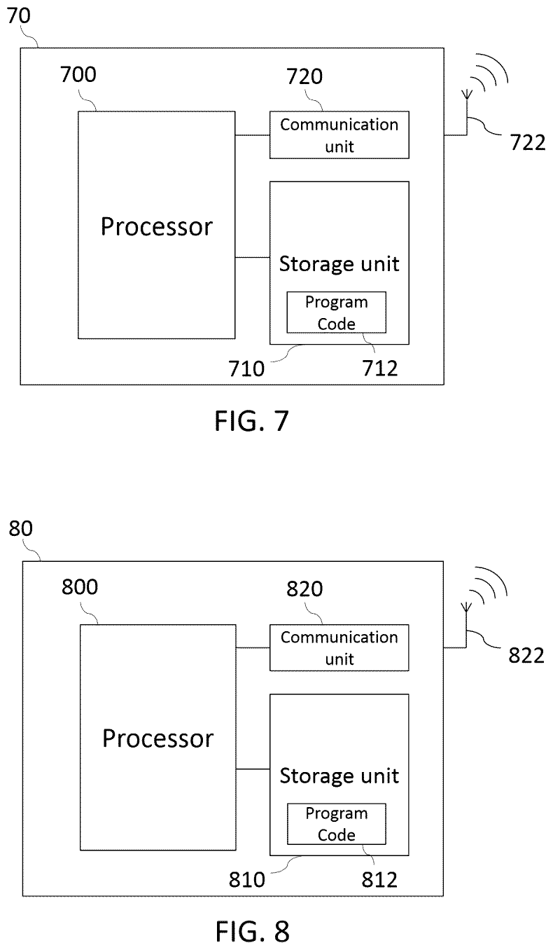

FIG. 7 relates to a schematic diagram of a wireless terminal 70 (e.g., a wireless communication terminal) according to an embodiment of the present disclosure. The wireless terminal 70 may be a user equipment (UE), a mobile phone, a laptop, a tablet computer, an electronic book or a portable computer system and is not limited herein. The wireless terminal 70 may include a processor 700 such as a microprocessor or Application Specific Integrated Circuit (ASIC), a storage unit 710 and a communication unit 720. The storage unit 710 may be any data storage device that stores a program code 712, which is accessed and executed by the processor 700. Embodiments of the storage unit 712 include but are not limited to a subscriber identity module (SIM), read-only memory (ROM), flash memory, random-access memory (RAM), hard-disk, and optical data storage device. The communication unit 720 may a transceiver and is used to transmit and receive signals (e.g. messages or packets) according to processing results of the processor 700. In an embodiment, the communication unit 720 transmits and receives the signals via at least one antenna 722 shown in FIG. 7.

In an embodiment, the storage unit 710 and the program code 712 may be omitted and the processor 700 may include a storage unit with stored program code.

The processor 700 may implement any one of the steps in exemplified embodiments on the wireless terminal 70, e.g., by executing the program code 712.

The communication unit 720 may be a transceiver. The communication unit 720 may as an alternative or in addition be combining a transmitting unit and a receiving unit configured to transmit and to receive, respectively, signals to and from a wireless network node (e.g., a base station).

FIG. 8 relates to a schematic diagram of a wireless network node 80 (e.g., a wireless communication node) according to an embodiment of the present disclosure. The wireless network node 80 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 80 may comprise (perform) at least one network function such as an access and mobility management function (AMF), a session management function (SMF), a user place function (UPF), a policy control function (PCF), an application function (AF), a location management function (LMF), etc. The wireless network node 80 may include a processor 800 such as a microprocessor or ASIC, a storage unit 810 and a communication unit 820. The storage unit 810 may be any data storage device that stores a program code 812, which is accessed and executed by the processor 800. Examples of the storage unit 812 include but are not limited to a SIM, ROM, flash memory, RAM, hard-disk, and optical data storage device. The communication unit 820 may be a transceiver and is used to transmit and receive signals (e.g., messages or packets) according to processing results of the processor 800. In an example, the communication unit 820 transmits and receives the signals via at least one antenna 822 shown in FIG. 8.

In an embodiment, the storage unit 810 and the program code 812 may be omitted. The processor 800 may include a storage unit with stored program code.

The processor 800 may implement any steps described in exemplified embodiments on the wireless network node 80, e.g., via executing the program code 812.

The communication unit 820 may be a transceiver. The communication unit 820 may as an alternative or in addition be combining a transmitting unit and a receiving unit configured to transmit and to receive, respectively, signals to and from a wireless terminal (e.g. a user equipment or another wireless network node).

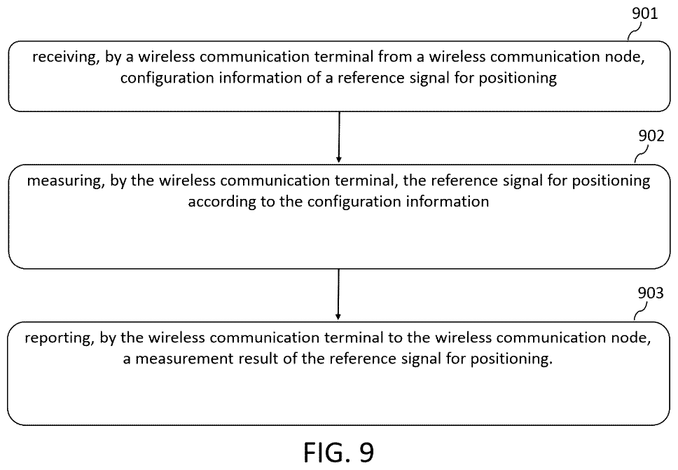

FIG. 9 shows a flowchart of a wireless communication method according to an embodiment of the present disclosure. In an embodiment, the wireless communication method may be performed by a wireless communication terminal, such as the wireless terminal 70 described above.

In an embodiment, the wireless communication method includes: receiving, by a wireless communication terminal (e.g., a UE) from a wireless communication node (e.g., a gNB), configuration information of a reference signal for positioning (e.g., the PRS) (operation 901); measuring, by the wireless communication terminal, the reference signal for positioning according to the configuration information (operation 902); and reporting, by the wireless communication terminal to the wireless communication node, a measurement result of the reference signal for positioning (operation 903).

Details of the wireless communication method can be ascertained by referring to the paragraphs above and will not be described herein.

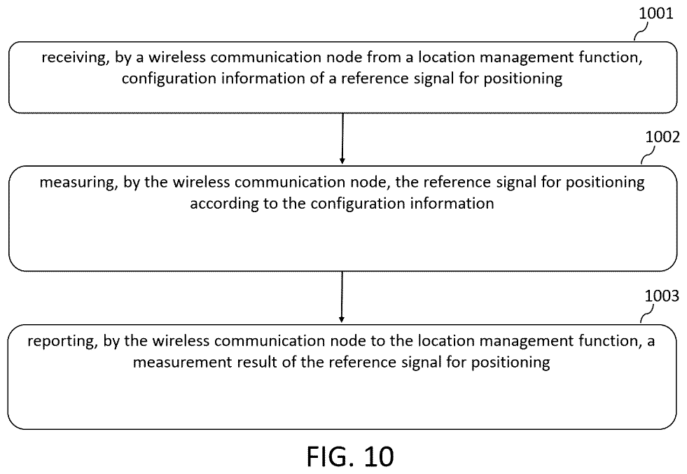

FIG. 10 shows a flowchart of a wireless communication method according to an embodiment of the present disclosure. In an embodiment, the wireless communication method may be performed by a wireless communication terminal, such as the wireless network node 80 described above.

In an embodiment, the wireless communication method includes: receiving, by a wireless communication node (e.g., a gNB) from a location management function, configuration information of a reference signal for positioning (operation 1001); measuring, by the wireless communication node, the reference signal for positioning according to the configuration information (operation 1002); and reporting, by the wireless communication node to the location management function, a measurement result of the reference signal for positioning (operation 1003).

Details of the wireless communication method can be ascertained by referring to the paragraphs above and will not be described herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method comprising:
receiving, by a wireless communication terminal from a wireless communication node, configuration information of a reference signal for positioning;
measuring, by the wireless communication terminal, the reference signal for positioning according to the configuration information;
reporting, by the wireless communication terminal to the wireless communication node, a measurement result of the reference signal for positioning; and
measuring, by the wireless communication terminal, a carrier phase of the reference signal for positioning on a first arrival path;
wherein the measurement result of the reference signal for positioning comprises at least one of: one or more carrier phase differences between resources of the reference signal for positioning; or one or more carrier phase differences between transmission reception points.

2. The wireless communication method of claim 1, wherein the reference signal for positioning comprises a sequence mapped to multiple contiguous symbols; and
wherein a number of the contiguous symbols is determined according to a positioning accuracy requirement.

3. The wireless communication method of claim 1, comprising:
measuring, by the wireless communication terminal, one or more carrier phases of the reference signal for positioning on one or more paths; and
measuring, by the wireless communication terminal, a carrier phase of the reference signal for positioning on a path different from a first arrival path.

4. The wireless communication method of claim 1, wherein the measurement result of the reference signal for positioning further comprises at least one of: one or more carrier phase differences between paths; or one or more carrier phase differences between frequency layers.

5. The wireless communication method of claim 1, comprising:
reporting, by the wireless communication terminal to the wireless communication node, one or more carrier phases of the reference signal for positioning with an indication of line of sight or non-line of sight; and
reporting, by the wireless communication terminal to the wireless communication node, one or more carrier phases of the reference signal for positioning with the indication of line of sight or non-line of sight with a confidence level,
wherein a report of the one or more carrier phases of the reference signal for positioning is absent in response to a probability of non-line of sight exceeding a threshold, and
wherein the threshold is configured by a long-term evolution positioning protocol layer.

6. The wireless communication method of claim 1, comprising:
determining, by the wireless communication terminal, a signal to noise ratio of the reference signal for positioning when measuring the reference signal for positioning;
reporting, by the wireless communication terminal to the wireless communication node, one or more carrier phases of the reference signal for positioning with at least one of: a signal to noise ratio, a signal to interference plus noise ratio, a reference signal received power, or a reference signal received quality;
reporting, by the wireless communication terminal to the wireless communication node, the measurement result of the reference signal for positioning on a first arrival path with a fine granularity;
reporting, by the wireless communication terminal to the wireless communication node, the measurement result of the reference signal for positioning on a path having a strongest receiving power with a fine granularity; and
reporting, by the wireless communication terminal to the wireless communication node, the measurement result of the reference signal for positioning on a path different from the first arrival path with a coarse granularity.

7. The wireless communication method of claim 1, comprising:
reporting, by the wireless communication terminal to the wireless communication node, a differential report associated to a carrier phase of the reference signal,
wherein the differential report comprises a differential value relative to the carrier phase of a first arrival path.

8. The wireless communication method of claim 1, comprising:
reporting, by the wireless communication terminal to the wireless communication node, at least one of: an identifier of the reference signal for positioning; an identifier of a resource of the reference signal for positioning; or an identifier of a set of the reference signal for positioning;
reporting, by the wireless communication terminal to the wireless communication node, the measurement result with a link between different frequency layers;
reporting, by the wireless communication terminal to the wireless communication node, a differential report with a link between a frequency layer and a reference frequency layer; and
reporting, by the wireless communication terminal to the wireless communication node, the measurement result based on each resource of the reference signal for positioning.

9. The wireless communication method of claim 1, comprising:
reporting, by the wireless communication terminal to the wireless communication node, Q candidates of carrier phases of the reference signal for positioning or Q candidates of carrier phase differences of the reference signal for positioning, wherein Q is an integer,
wherein the Q candidates of carrier phases or the Q candidates of carrier phase differences of the reference signal for positioning comprise Q integers of integer parts and corresponding Q floats of fractional parts.

10. The wireless communication method of claim 1, comprising:
reporting, by the wireless communication terminal to the wireless communication node, Q pair candidates of carrier phase differences of the reference signal for positioning, wherein Q is an integer,
reporting, by the wireless communication terminal to the wireless communication node, Q pair candidates of carrier phases or carrier phase differences of the reference signal for positioning after a de-correlation process, wherein Q is an integer;
reporting, by the wireless communication terminal to the wireless communication node, Q pair candidates of carrier phases or carrier phase differences of the reference signal for positioning after a de-correlation process and an optimal estimation process, wherein Q is an integer;
reporting, by the wireless communication terminal to the wireless communication node, a gesture of the wireless communication terminal with timing error groups not in one plane;
reporting, by the wireless communication terminal to the wireless communication node, a carrier phase of the reference signal for positioning based on a channel impulse response;
wherein a number of times of measuring the reference signal for positioning before the measurement result being reported is configured by a network; and
reporting, by the wireless communication terminal to the wireless communication node, a carrier phase of the reference signal for positioning with at least one of: a location of the wireless communication terminal; an indication of a measurement number; or distance information between the wireless communication terminal and the wireless communication node.

11. A wireless communication method comprising:
receiving, by a wireless communication node from a location management function, configuration information of a reference signal for positioning;
measuring, by the wireless communication node, the reference signal for positioning according to the configuration information;
reporting, by the wireless communication node to the location management function, a measurement result of the reference signal for positioning; and
measuring, by the wireless communication node, a carrier phase of the reference signal for positioning on a path different from a first arrival path,
wherein the measurement result of the reference signal for positioning comprises at least one of: one or more carrier phase differences between resources of the reference signal for positioning; or one or more carrier phase differences between transmission reception points.

12. The wireless communication method of claim 11, comprising:
measuring, by the wireless communication node, one or more carrier phases of the reference signal for positioning on one or more paths with the same receiving timing error group; and
reporting, by the wireless communication node to the location management function, one or more carrier phases of the reference signal for positioning with an indication of receiving timing error group.

13. The wireless communication method of claim 11, wherein the reference signal for positioning comprises a sequence mapped to multiple contiguous symbols,
wherein a number of the contiguous symbols is determined according to a positioning accuracy requirement.

14. The wireless communication method of claim 11, comprising:
measuring, by the wireless communication node, one or more carrier phases of the reference signal for positioning on one or more paths;
measuring, by the wireless communication node, a carrier phase of the reference signal for positioning on a path different from a first arrival path,
wherein the measurement result of the reference signal for positioning further comprises at least one of: one or more carrier phase differences between paths; one or more carrier phase differences between frequency layers.

15. The wireless communication method of claim 11, comprising:
reporting, by the wireless communication node to the location management function, one or more carrier phases of the reference signal for positioning with an indication of line of sight or non-line of sight; and
reporting, by the wireless communication node to the location management function, one or more carrier phases of the reference signal for positioning with the indication of line of sight or non-line of sight with a confidence level,
wherein a report of the one or more carrier phases of the reference signal for positioning is absent in response to a probability of non-line of sight exceeding a threshold, and
wherein the threshold is configured by a long-term evolution positioning protocol layer.

16. The wireless communication method of claim 11, comprising:
determining, by the wireless communication node, a signal to noise ratio of the reference signal for positioning when measuring the reference signal for positioning.

17. The wireless communication method of claim 11, comprising:
reporting, by the wireless communication node to the location management function, one or more carrier phases of the reference signal for positioning with at least one of: a signal to noise ratio, a signal to interference plus noise ratio, a reference signal received power, or a reference signal received quality;
reporting, by the wireless communication node to the location management function, the measurement result of the reference signal for positioning on a first arrival path with a fine granularity;
reporting, by the wireless communication node to the location management function, the measurement result of the reference signal for positioning on a path having a strongest receiving power with a fine granularity;
reporting, by the wireless communication node to the location management function, the measurement result of the reference signal for positioning on a path different from the first arrival path with a coarse granularity; and
reporting, by the wireless communication node to the location management function, a differential report associated to a carrier phase of the reference signal,
wherein the differential report comprises a differential value relative to the carrier phase of a first arrival path.

18. The wireless communication method of claim 11, comprising:
reporting, by the wireless communication node to the location management function, at least one of: an identifier of the reference signal for positioning; an identifier of a resource of the reference signal for positioning; or an identifier of a set of the reference signal for positioning;
reporting, by the wireless communication node to the location management function, the measurement result with a link between different frequency layers;
reporting, by the wireless communication node to the location management function, a differential report with a link between a frequency layer and a reference frequency layer;
reporting, by the wireless communication node to the location management function, the measurement result based on each resource of the reference signal for positioning; and
reporting, by the wireless communication node to the location management function, Q candidates of carrier phases of the reference signal for positioning or Q candidates of carrier phase differences of the reference signal for positioning, wherein Q is an integer,
wherein the Q candidates of carrier phases or the Q candidates of carrier phase differences of the reference signal for positioning comprise Q integers of integer parts and corresponding Q floats of fractional parts.

19. The wireless communication method of claim 11, comprising:
reporting, by the wireless communication node to the location management function, Q pair candidates of carrier phase differences of the reference signal for positioning, wherein Q is an integer;
reporting, by the wireless communication node to the location management function, Q pair candidates of carrier phases or carrier phase differences of the reference signal for positioning after a de-correlation process, wherein Q is an integer;
reporting, by the wireless communication node to the location management function, Q pair candidates of carrier phases or carrier phase differences of the reference signal for positioning after a de-correlation process and an optimal estimation process, wherein Q is an integer;
reporting, by the wireless communication node to the location management function, a gesture of the wireless communication terminal with timing error groups not in one plane;
reporting, by the wireless communication node to the location management function, a carrier phase of the reference signal for positioning based on a channel impulse response;
wherein a number of times of measuring the reference signal for positioning before the measurement result being reported is configured by a network; and
reporting, by the wireless communication node to the location management function, a carrier phase of the reference signal for positioning with at least one of: a location of the wireless communication terminal; an indication of a measurement number; or
distance information between the wireless communication terminal and the wireless communication node.

20. A wireless communication terminal, comprising:
a communication unit; and
a processor configured to: receive, by the communication unit from a wireless communication node, configuration information of a reference signal for positioning; measure the reference signal for positioning according to the configuration information; report, by the communication unit to the wireless communication node, a measurement result of the reference signal for positioning; and measure a carrier phase of the reference signal for positioning on a first arrival path,
wherein the measurement result of the reference signal for positioning comprises at least one of: one or more carrier phase differences between resources of the reference signal for positioning; or one or more carrier phase differences between transmission reception points.
